(19) United States
(12) Patent Application Publication
(10) Pub. No.: US 2007/0156829 A1
(43) Pub. Date: Jul. 5, 2007

(54) Messaging system with secure access

(76) Inventors: Scott Deboy, Hillsboro, OR (US); Kenneth Majors, Lake Oswego, OR (US)

Correspondence Address: CHERNOFF, VILHAUER, MCCLUNG & STENZEL, 1600 ODS TOWER, 601 SW SECOND AVENUE, PORTLAND, OR, 97204-3157, US

(21) Appl. No.: 11/649,701

(22) Filed: Jan. 3, 2007

Related U.S. Application Data
(60) Provisional application No. 60/756,635, filed on Jan. 5, 2006.

(51) Int. Cl. G06F 15/16

(52) U.S. Cl. 709/206

(57) ABSTRACT

Secure access for a user of a messaging system is provided by requiring association of the user with an administrator regulating the user's use of the messaging system and by enabling communication with other users only in the event that a relationship of trust has been established between the other user and the administrator.

### CROSS-REFERENCE TO RELATED APPLICATIONS

This application claims the benefit of U.S. Provisional Application No. 60/756,635, filed Jan. 5, 2006.

### BACKGROUND OF THE INVENTION

The present invention relates to a messaging system and, more particularly, to a messaging system providing secure access for users.

A computer-based messaging system provides a mechanism to communicatively interconnect remotely located computer users. A messaging system may be used to transmit text messages between two remotely located users or between multiple users in a group or chat room. On the other hand, the messaging system may comprise a conferencing system that enables audio, video, and/or text communications and file and/or application sharing between a plurality of remotely located users. Secure access, assuring the identity of persons utilizing the messaging system, is important for user safety and privacy. For example, a messaging system may be used to enable a child to engage in instant messaging or chatting with other computer users connected to the Internet, a global network of interconnected computer systems. Unfortunately, there have been well publicized incidents where a child's safety has been jeopardized as a result using a computer-based messaging system to communicate with others. Determining the identity of individuals utilizing a messaging system and regulating their access to the system is problematic.

What is desired, therefore, is a messaging system providing secure access for the users of the system.

### BRIEF DESCRIPTION OF THE DRAWINGS

FIG. 1 is a block diagram of a messaging system.

FIG. 2 is a block diagram of a user interface device for use with a messaging system.

FIG. 3 is a flow diagram of a process for creating a local account for an administrator of a local user interface device.

FIG. 4 is a flow diagram of a process for creating a central account at an authentication service for an administrator of a messaging system.

FIG. 5 is a flow diagram of a process for creating an account for a designated of a messaging system.

FIG. 6 is a flow diagram of a process for user entry into the messaging system.

FIG. 7 is a flow diagram of a process for enabling user to user communication with the messaging system.

### DETAILED DESCRIPTION OF PREFERRED EMBODIMENTS

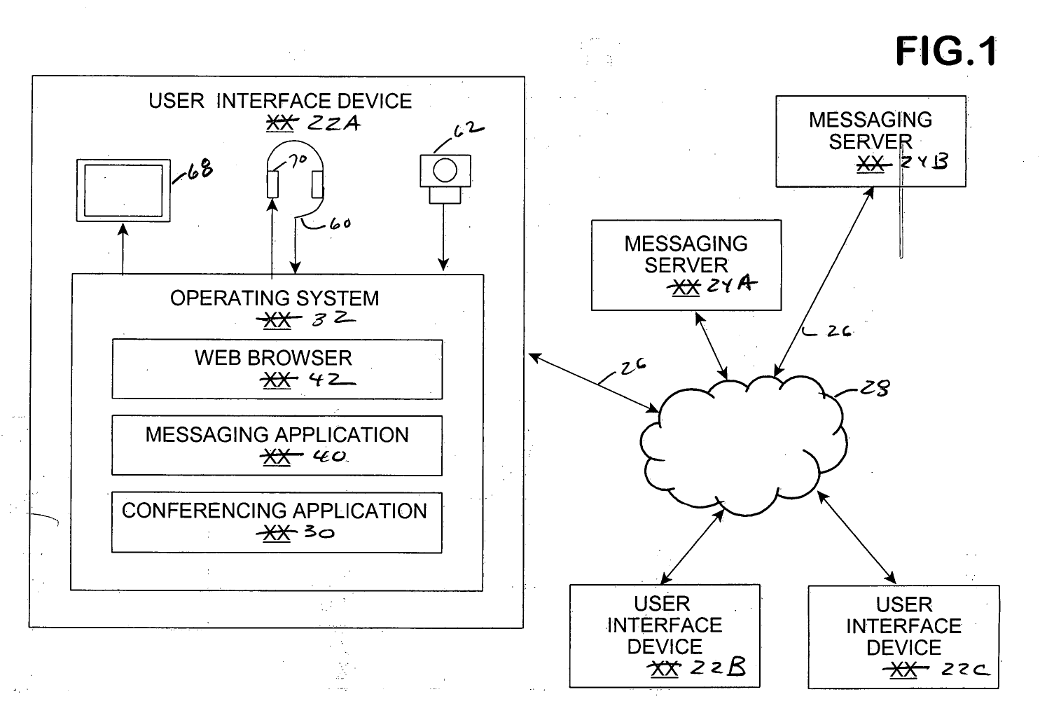

Referring in detail to the drawings where similar parts are identified by like reference numerals, and, more particularly to FIG. 1, a messaging system 20 comprises a plurality of remotely located, user operated, user interface devices 22a, 22b, 22c that can be communicatively interconnected. The user interface devices may be interconnected as a plurality of peers that simultaneously function as both a “client” and a “server” to other nodes of a network of user interface devices. However, the user interface devices are commonly communicatively interconnected through one or more messaging servers 24A, 24B with the user interface devices acting as clients sending requests to a respective messaging server and receiving information from the server. The communication links 26 between users may comprise portions of a local area network (LAN) within a facility and/or a wide area network (WAN) that commonly includes the Internet 28, a global network of communicatively interconnected computing systems.

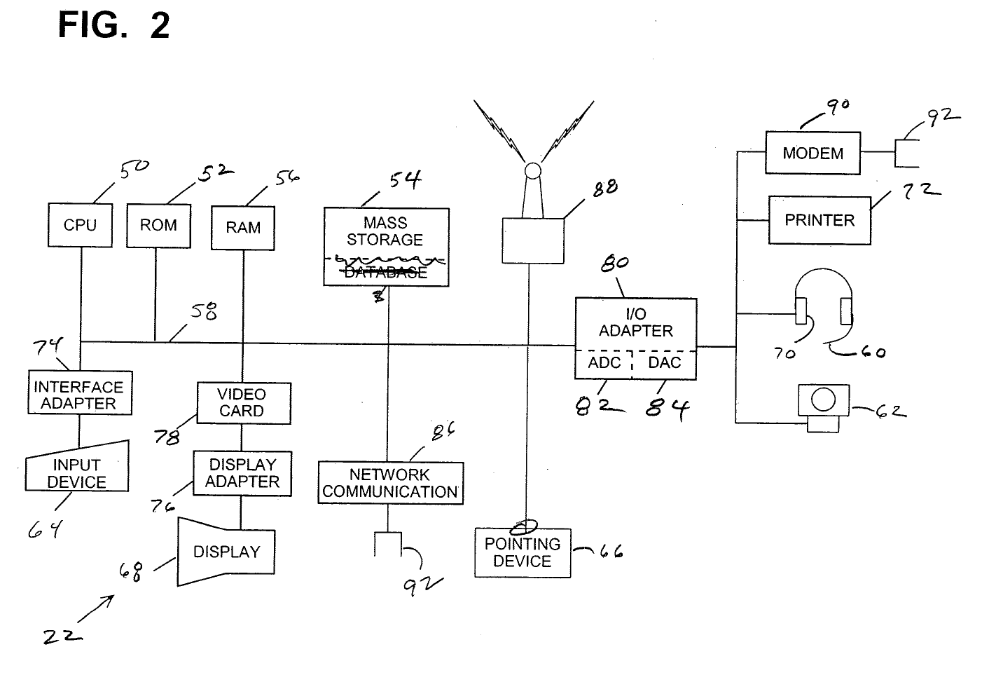

A user interface device 22 typically comprises a personal computer but may comprise other types of computing devices, such as, personal digital assistants (PDAs) or cellular telephones, that are capable of connecting to and communicating over a computer network. Referring to FIG. 2, a user interface device 22 typically comprises a microprocessor-based, central processing unit (CPU) 50 that fetches data and instructions, processes the data according to the instructions, and stores or transmits the results to an output device or another data processing device. Typically, basic operating instructions used by the CPU 50 are stored in nonvolatile memory or storage, such as a flash memory or read only memory (ROM) 52. Instructions and data used by application programs, including a messaging client program, are typically stored in a nonvolatile mass storage or memory 54, such as a disk storage unit or a flash memory. The data and instructions are typically transferred from the mass storage 54 to a random access memory (RAM) 56 and fetched from RAM by the CPU during execution. Data and instructions are typically transferred between the CPU and the mass storage over a system bus 58.

The user interface device may also include a plurality of attached input/output (I/O) devices and other peripheral devices. Input devices may include an audio capture device 60, such as a microphone, a video capture device 62, such as a digital video camera, a keyboard 64 for textual input and a pointing device 66, such as a mouse, a trackball or a touch screen display. Output devices commonly include a display 68 for rendering video, text and other visual information, headphones 70 or speakers for audio output and a printer 72 or plotter to render hard copies of documents and images. Under the control of the CPU, data is transmitted to and received from each of the attached devices over a communication channel connected to the system bus 58. Typically, each device is attached to the system bus by way of an adapter, such as an interface adapter 74 providing an interface between the keyboard 64 and the system bus. Likewise, a display adapter 76 commonly provides an interface between the display 68 and a video card 78 that processes video data under the control of the CPU and is communicatively connected to the system bus. The printer 72 and similar peripheral devices are typically connected to the system bus by one or more input-output (I/O) adapters 80 commonly including an analog to digital converter (ADC) 82 and a digital to analog converter (DAC) 84.

The user interface device 22 also includes communication facilities for communicatively interconnecting with other data processing devices including the messaging server and other user interface devices. These facilities may include a network interface card 86 or circuitry, and/or one or more modems 90 including ports 92 for connection to a telephone system or a wired network. In addition, the user interface device may be equipped with a wireless data transceiver 88 for wireless connection to the communication network. The communications facilities provide communication links 26 enabling connection to and communication with one or more computer networks such as a wide area network (WAN), commonly including the Internet, or a local area network (LAN), as appropriate at the user's location.

The user interface device 22 typically comprises an operating system 32 which controls the basic data processing operations of the device and commonly includes a web browser program enabling user interaction with the World Wide Web, a global information space, accessible by computers connected Internet. In addition, the user interface device comprises a messaging application program 40 that operates within the operating system. Messaging application programs typically enable instant messaging comprising text and, in some cases, audio/video communication between two or more users of the messaging system. Messaging application programs include, for examples, the YAHOO! MESSENGER and MSN MESSENGER communication clients and protocols.

Preferably, the user interface device includes a messaging application program 40 comprising a JABBER client that transmits and receives messages utilizing the JABBER® communication protocols. Jabber is an open XML (eXtensible Markup Language) protocol for instant messaging. Users of Jabber establish an account on a messaging server, such as the messaging server 24A, known as a Jabber server, and obtain an address, similar to an e-mail address, known as a Jabber ID (JID), for the account. To send a message, the user opens the messaging client application 40 on the local user interface device and logs onto the messaging server on which the user's account is established. The user transmits a message addressed to the second user's account (the destination account) which may be on the same or a different messaging server, for example messaging server 24B. When the message is received at the first server 24A where the sender's account is registered, the server opens a connection to the destination server on which the second user has the destination account and transmits the message, in one or more hops, to the destination server. The destination server delivers the message to a messaging application program running on the second user's user interface device and the message is rendered on the display or other playback device the second user. Moreover, Jabber enables conferencing with groups of users or chat rooms and the Jabber server may include one or more transport programs enabling translation of messages so that the user of the Jabber application program can communicate with users of other messaging applications, such as YAHOO! MESSENGER.

The messaging application may be separate from or a component of a conferencing application program 30 that operates within the operating system. A conferencing system commonly enables audio, video, and text communications and file and/or application sharing between a plurality of users. The conferencing program enables capture, playback, streaming, transcoding and transmission of data streams for video, audio and other time based media. A user interface device 22 for use with a conferencing system typically includes a video capture device, typically a digital video camera 62, and an audio capture device, typically a microphone 60, to capture, respectively, video and audio. Video and audio are typically played back, respectively, on a display 68 and a speaker or headphones 70.

Providing secure access and limiting the use of the message system to communications with trusted individuals, is important for the safety and privacy of users of a messaging system. For example, secure access is particularly important when the messaging system is used by children. However, limiting access to a messaging system and identifying the participant(s) in a messaging session is problematic, particularly if video conferencing is not in use. The current inventor concluded that use of a messaging system could be limited to communication with trusted individuals by a process enabling an administrator, responsible for regulating the use of the messaging system by a user, to validate the identity of the user and the identities of the persons with whom the user is permitted to communicate using the messaging system.

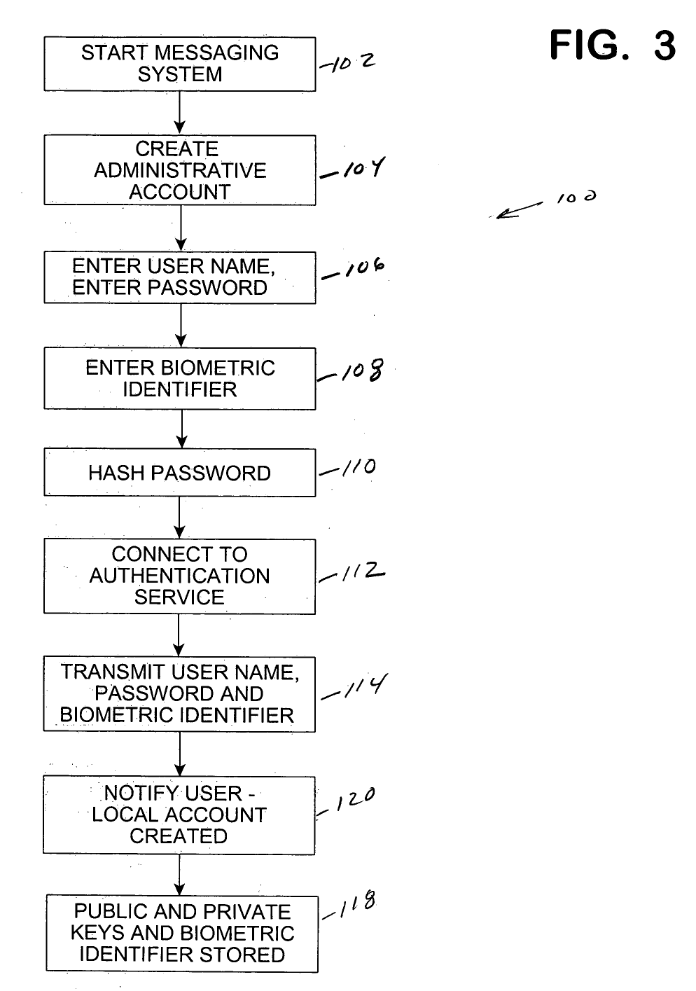

Referring to FIG. 3, the messaging application 40 includes program instructions providing an administrative process for securing messaging system access. The process is initiated by establishing an administrative account 100 that will be used to designate a user authorized to communicate with the messaging system and to establish trust relationships with prospective communicants. The administrative account is established by an administrator responsible for regulating the use of the messaging system, for example, a parent desirous of regulating a child's use of a home computer to communicate with others utilizing the messaging system. When operation of the messaging system is initiated at the local user interface device 102, the administrator can select an option enabling the creation of a local administrative account 104. An interactive enrollment screen is rendered on the display of the user interface device enabling the administrator to enter a user name and a password to be used in accessing the administrative account 106. Since user names and passwords are relatively easily discoverable with spyware or keyboard logging devices, the administrator is also instructed to enter a biometric identifier 108. The biometric identifier could, for examples, be a fingerprint, a retina scan or a voice print. A biometric identifier is more difficult to discover or counterfeit than the key strokes that comprise a user name or password. Preferably, the system instructs the user to utter a phrase which is recorded and converted to a digital voice print which will be used to secure access to the administrator's account. To further ensure the identity of persons attempting to gain access to the local administrative account, additional data such as a credit card or information likely to be known only to the administrator, may be associated with the account and required when seeking access to the account. When the administrator of the local user interface device has entered the user name, password and biometric identifier, the local interface device is communicatively interconnected to an authentication service 112. The local user interface device hashes the password 110 and transmits the hashed password, the user name and the biometric identifier to the authentication service 114.

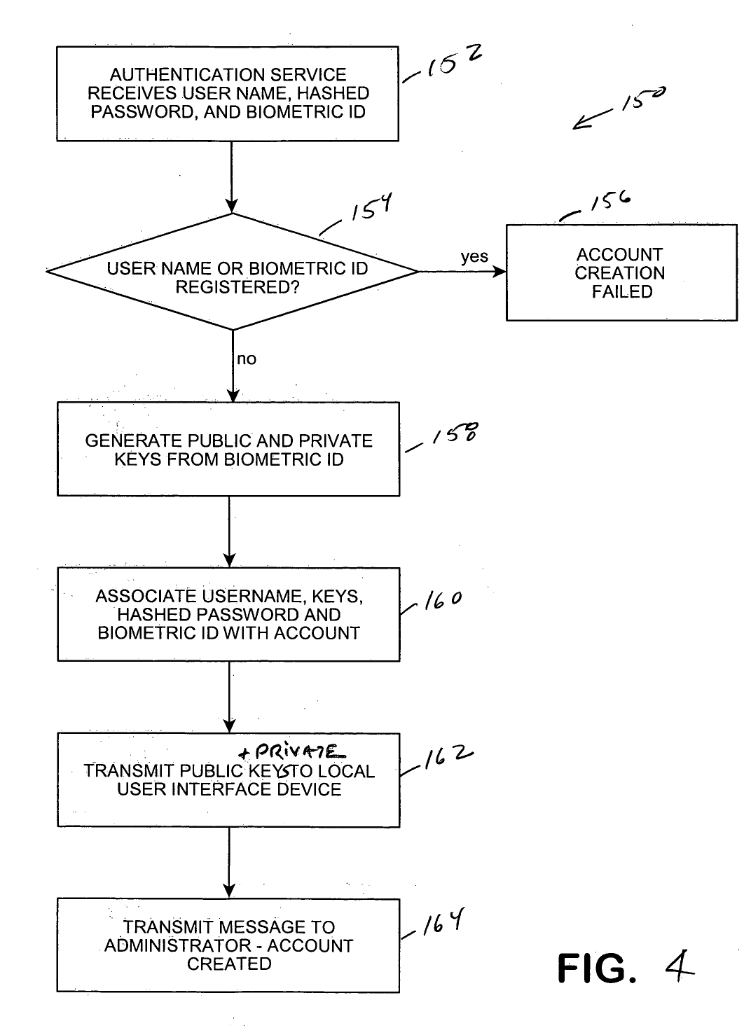

Referring to FIG. 4, the authentication service initiates creation of a central administrative account for the administrator of the local user interface device to use in validating access of users of the messaging system 150. An administrator is not normally permitted to establish more than one administrative account and the authentication service verifies that the biometric identifier and/or username received from the local device 152 is not already registered with the authentication service 154. If the user name or the biometric identifier are already registered with the authentication service, a new central administrative account is not created by the authentication service 156. Otherwise, for encryption and decryption of communications, the authentication service generates a public key and a private key based upon the biometric identifier 158. The username, public and private keys, biometric identifier, and hashed password are associated with an administrative account in a database 160. The authentication service transmits the keys to the local user interface device 162 and informs the administrator of the local user interface device of the successful creation of a central administrative account 164.

The local user interface device notifies the administrator that the local administrative account, with the user name and password selected by the administrator, has been created 120 and that the public and private keys and the biometric identifier have been received and are stored on the local interface device in association with the local administrative account 118.

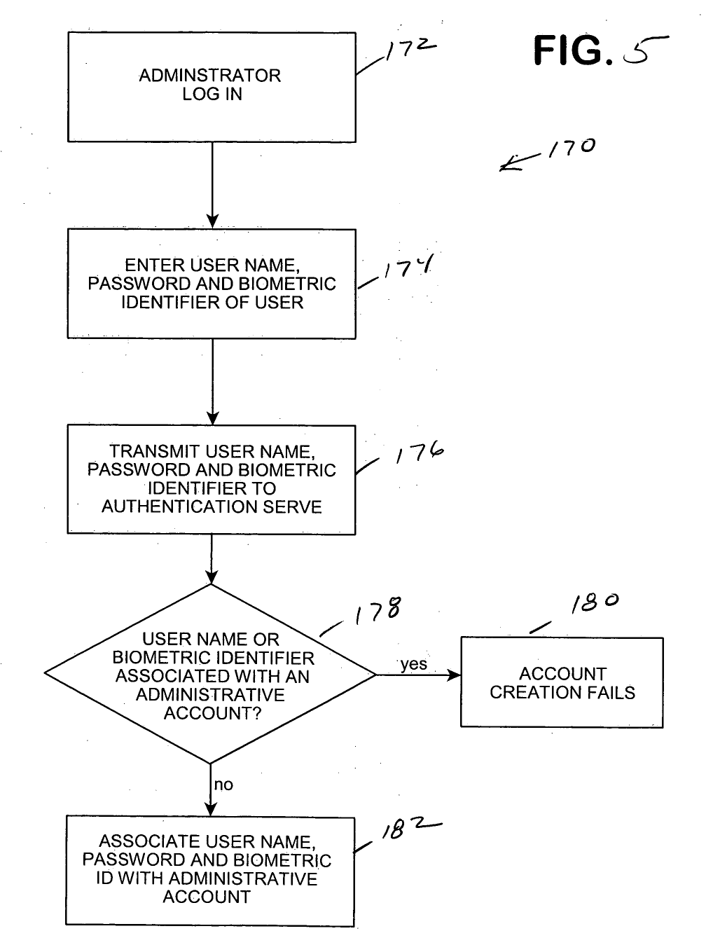

Referring to FIG. 5, once the local and central administrative accounts have been established, the administrator may create a user account 170 to enable designation of a user as authorized to utilize the messaging system for communication. To create the user account, the administrator initiates the messaging system and logs into the local administrative account by entering the user name, password and biometric identifier associated with the administrative account 172. The user account is created in a manner similar to the creation of the administrative account. A user name and a password is entered for the user account 174. In addition, a biometric identifier for the designated user is associated with the user account. Preferably, the designated user is prompted to record a phrase which is converted to a voice print that is associated with the user account. The user account creation may require the administrator and the user to be in the same physical location because both must provide a biometric identifier to establish the user account. The local user interface device hashes the password, connects to the authentication service and transmits the user name, hashed password and biometric identifier to the authentication service 176. Preferably, the user name, and biometric identifier of the user are associated with only one administrative account. To limit access to the messaging system, a user account may not normally create another user account or an administrative account. The authentication service determines whether the user name and biometric identifier are already associated with a user account 178 and, if they are, the creation of the user account fails 180. If the user name, password and biometric identifier are not already associated with an administrative account, the authentication service associates the user account data, including the user name, the hashed password and the biometric identifier, with the central administrative account of the administrator that created the user account 182.

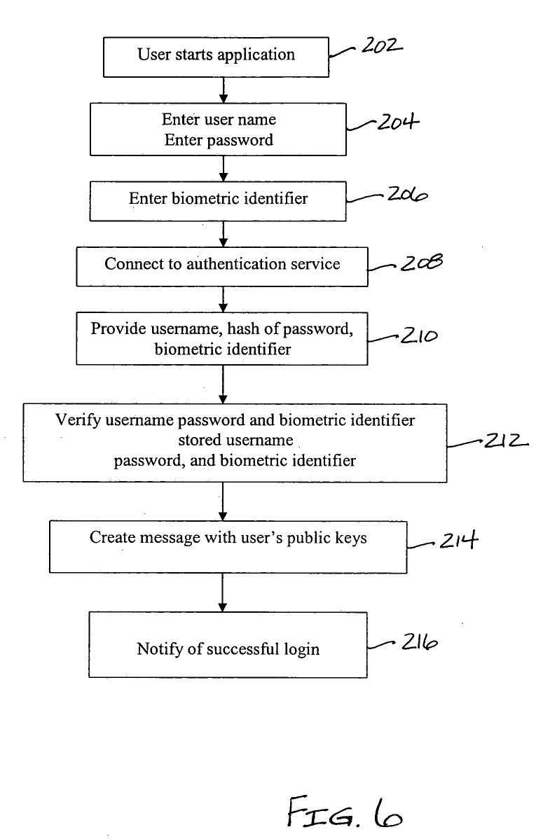

Referring to FIG. 6, to use the messaging system, the user starts the messaging application 202 on the local user interface device and logs onto the messaging system. In response to a prompt the user enters the user name together with the password for the user's account 204. In order to further ensure that the individual logging onto the messaging system is the proper user of the user account, and not an imposter, the user must also enter the biometric identifier 206. For example, preferably the biometric identifier is a voice print and, after entering the user name and password, the user may be prompted to utter a phrase which the local user interface device transforms to a voice print. The local user interface device connects to the authentication service 208 and transmits the user name, a hash of the password, and the biometric identifier entered by the user to the authentication service 210. The authentication service verifies the submitted user name, the hashed password, and the biometric identifier against corresponding data that was stored when the user account was established 212. If the authentication service verifies that current user is the user authorized to access the messaging system through the respective user account, then a message to the user is created notifying the user that the log in was successful which is encrypted with the user's public key 214 and transmitted to the user 216. The system provides secure access to the messaging system by authenticating the identity of the individual operating the local user interface device as the specific user authorized by the administrator to use the messaging system.

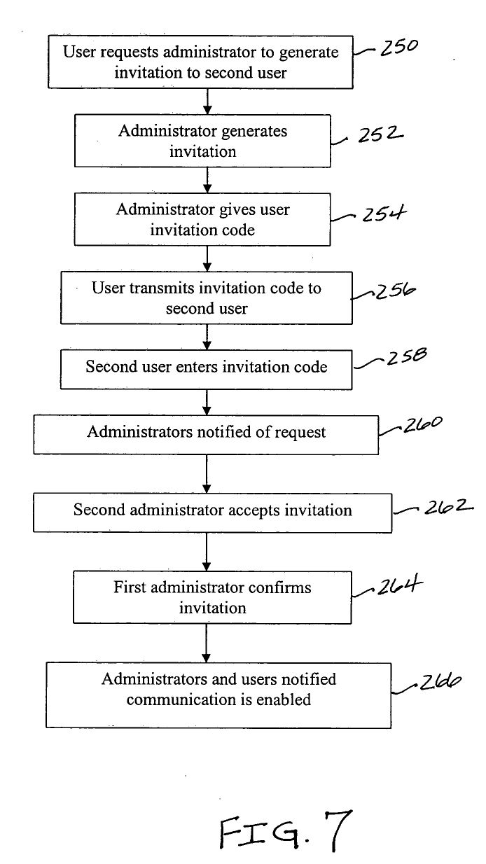

To provide a secure messaging environment for the designated user, the messaging system limits the user's communications to other users of the system who have been invited to communicate with the user and who have established a relationship of trust with the user and the administrator. Referring to FIG. 7, to enable communication with another person utilizing the messaging system, the user requests that the administrator generate an invitation to the prospective communicant 250. The administrator may elect to generate an invitation including information that the administrator expects will describe the second user, such as the second user's name 252. The administrator provides an invitation code to the user of the local user interface 254 device and the invitation code is transmitted to the second user 256.

The second user is notified of the invitation and is instructed to log on to the messaging system and activate a process for accepting the invitation. When the acceptance process in activated, the second user is prompted to enter the invitation code provided by the first user 258. When the invitation code is entered, the first administrator and a second administrator, associated with the second user, are notified of the invitation and the pending acceptance 260. When the administrators log onto the messaging system, they can respectively view information related to the invited or inviting users and the administrators associated with the respective users. In addition, messages may be exchanged by the administrators to aid the administrators in reaching a decision concerning the pending invitation. The messages may likewise be stored for later retrieval if the receiving administrator is not currently on-line.

If the second administrator is satisfied with the trustworthiness of the first user and the first administrator, the second administrator can accept the invitation 262 on behalf of the second user. The messaging system permits either administrator to revoke an invitation at any time terminating the process for establishing the new communication relationship. The first administrator is notified of the acceptance and, if satisfied with the trustworthiness of the second user and second administrator, can elect to confirm the accepted invitation 264. A trust relationship is thus established between the first user and the second user, and stored in the database of the authentication service. The administrators and the users are notified of the successfully completed invitation process and communication between users with the messaging system is enabled 266. In a similar manner, the system may be used to establish a trust relationship between a user and the members of a group of users.

To communicate with each other utilizing the messaging system, the users log onto the system and the respective public keys are exchanged. The messaging system provides notification to each user of the presence of the other user and enabling the users to exchange instant messages. If the receiving user is not currently online, the messages may be stored for later retrieval. The users appear in each other's list of authorized communicants which displayable by the user interface device and may initiate and participate in online chatting with the other. The messaging system enables an administrator of a local user interface device to revoke the permission of the user to communicate with the second user at any time. In the event permission is revoked, the users and the administrator associated with each user are notified of the revocation.

The messaging system provides secure access for users by verifying the identity of each users communicating with the messaging system and enabling communication only with other users with whom a trust relationship has been established.

The detailed description, above, sets forth numerous specific details to provide a thorough understanding of the present invention. However, those skilled in the art will appreciate that the present invention may be practiced without these specific details. In other instances, well known methods, procedures, components, and circuitry have not been described in detail to avoid obscuring the present invention.

All the references cited herein are incorporated by reference.

The terms and expressions that have been employed in the foregoing specification are used as terms of description and not of limitation, and there is no intention, in the use of such terms and expressions, of excluding equivalents of the features shown and described or portions thereof, it being recognized that the scope of the invention is defined and limited only by the claims that follow.

I (we) claim:

1. A method for providing secure access to a computer based messaging system comprising the steps of:
(a) establishing an indicator of an identity of an administrator of a first local device to be used by a user as an interface to access said messaging system;
(b) associating an identifier of a prospective first user of said messaging system with said identity of said administrator; and
(c) enabling access to said messaging system by said first user in response to said association.

2. The method for providing secure access of claim 1 wherein said indicator of said identity of said administrator comprises a biometric identifier.

3. The method for providing secure access of claim 2 wherein said biometric identifier comprises a voice print.

4. The method for providing secure access of claim 1 wherein said indicator of said identity of said administrator comprises a hashed password.

5. The method for providing secure access of claim 1 wherein said indicator of said identity of said first user comprises a biometric identifier.

6. The method for providing secure access of claim 5 wherein said biometric identifier comprises a voice print.

7. The method for providing secure access of claim 1 wherein said indicator of said identity of said first user comprises a hashed password.

8. The method for providing secure access of claim 1 further comprising the steps of:
(a) issuing an invitation to a second user to communicate with said first user utilizing said messaging system;
(b) acceptance of said invitation by said second user and a second administrator associated with said second user;
(c) confirmation of said acceptance by said administrator of said first local user interface device; and
(d) in response to said acceptance and said confirmation, enabling communication between said first user and said second user.

9. The method for providing secure access of claim 8 wherein said invitation includes data descriptive of at least one of said first user and said administrator of said first user interface device.

10. The method for providing secure access of claim 8 wherein said invitation includes data expected to describe said second user.

11. A method for providing secure access to a computer based messaging system comprising the steps of:
(a) establishing an identity of a first user of said messaging system;
(b) establishing an identity of a second user of said messaging system; and
(c) enabling said first user to communicate with said second user with said messaging system if a trusted communicant relationship has been established between said first and said second user.

12. The method for providing secure access of claim 11 wherein the step of establishing an identity of a first user comprises the steps of:
(a) requiring said first user to provide an identifier as a condition of contemporaneous enablement of said messaging system;
(b) comparing said contemporaneously provided identifier to an identifier previously associated with an authorized user of said messaging system; and
(c) enabling use of said messaging system by said first user if said contemporaneously provided identifier substantially matches said previously associated identifier.

13. The method for providing secure access of claim 12 wherein said identifier comprises a biometric identifier.

14. The method for providing secure access of claim 13 wherein said biometric identifier comprises a voice print.

15. The method for providing secure access of claim 12 wherein said identifier comprises a hashed password.

16. The method for providing secure access of claim 11 wherein the step of establishing a trusted communicant relationship comprises the steps of:
(a) inviting said second user to establish a communicant relationship with said first user, said invitation originating from a first administrator regulating use of said messaging system by said first user;
(b) acceptance of said invitation by a second administrator, said second administrator regulating use of said messaging system by said second user;
(c) confirming said acceptance by said first administrator; and
(d) enabling communication between said first user and said second user with said messaging system.

17. The method for providing secure access of claim 16 further comprising the steps of:
(a) requiring said first user to provide an identifier as a condition of contemporaneous enablement of said messaging system;
(b) comparing said contemporaneously provided identifier to an identifier previously associated with said first user of said messaging system;
(c) enabling said first user to use said messaging system to communicate with said second user if said contemporaneously provided identifier substantially matches said previously associated identifier;
(d) requiring said second user to provide an identifier as a condition of contemporaneous enablement of said messaging system;
(e) comparing said contemporaneously provided identifier to an identifier previously associated with said second user of said messaging system; and
(f) enabling said second user to use said messaging system to communicate with said first user if said contemporaneously provided identifier substantially matches said previously associated identifier.

18. The method for providing secure access of claim 17 further comprising the steps of:
(a) establishing an identifier of said first administrator;
(b) associating an identifier of said first user with said identifier of said first administrator; and
(c) enabling access to said messaging system by said first user in response to said association.

19. The method for providing secure access of claim 17 wherein said identifier of at least one of said first administrator and said first user comprises a biometric identifier.

20. The method for providing secure access of claim 17 wherein said identifier of at least one of said first administrator and said first user comprises a hashed password.
